(19) United States
(12) Patent Application Publication
(10) Pub. No.: US 2026/0103117 A1
(43) Pub. Date: Apr. 16, 2026

(54) ELECTRIC RAIL INFRASTRUCTURE FOR WORK MACHINES

(71) Applicant: Caterpillar Inc., Peoria, IL (US)

(72) Inventors: Igor STRASHNY, Tucson, AZ (US); Roopa Rajesh, Tucson, AZ (US)

(73) Assignee: Caterpillar Inc., Peoria, IL (US)

(21) Appl. No.: 18/914,715

(22) Filed: Oct. 14, 2024

(51) Int. Cl. B60M 7/00; B60L 50/53; B60L 53/14; B60L 53/57; B60M 1/30

(52) U.S. Cl. CPC B60M 7/00; B60L 50/53; B60L 53/14; B60L 53/57; B60M 1/30; B60L 2200/40

(57) ABSTRACT

An electric rail infrastructure for a work machine is disclosed. The electric rail infrastructure comprises: a plurality of powered rails; a plurality of energy interfaces positioned throughout the plurality of powered rails; a power module connected to the plurality of energy interfaces for providing electrical power to the plurality of powered rails; a plurality of electric clamps positioned on each end of the powered rails, each electric clamp having at least one resistor.

### TECHNICAL FIELD

The present disclosure relates generally to dynamic charging systems for work machines and more specifically to an electrical rail infrastructure designed to provide continuous power to work machines during operation.

### BACKGROUND

In various industries, such as construction, mining, and agriculture, work machines such as excavators, backhoes, front-end loaders, shovels, draglines, skid steers, wheel loaders, and tractors perform heavy-duty tasks that require significant power. Traditionally, these machines rely on batteries or diesel engines for their power supply. However, these power sources necessitate frequent interruptions for refueling or recharging, leading to operational inefficiencies and increased downtime.

Electrified rail infrastructures have emerged as a potential solution to address the power demands of these work machines. These systems provide continuous electrical power to the machines while they are in operation, eliminating the need for frequent stops to recharge batteries. Existing solutions typically involve static charging stations where machines must remain stationary to recharge, which disrupts workflow and leads to downtime.

Others have attempted to enhance the performance and longevity of busbars, such as U.S. Pat. No. 7703589B2, which discloses a conductor rail support system for electrically-propelled vehicles. U.S. Pat. No. 7703589B2 focuses on ensuring stable support and electrical contact for conductor rails used in electrified transportation systems. However, the system described in this patent has limitations in terms of adaptability to different environmental conditions and the ease of installation and maintenance, highlighting the need for further improvements in these areas.

It can therefore be seen that a need exists for an improved dynamic charging system that can be easily installed and provide a continuous and reliable power supply to work machines during operation.

### SUMMARY

In accordance with one aspect of the disclosure, an electric rail infrastructure for a work machine is disclosed. The electric rail infrastructure comprises: a plurality of powered rails; a plurality of energy interfaces positioned throughout the plurality of powered rails; a power module connected to the plurality of energy interfaces for providing electrical power to the plurality of powered rails; a plurality of electric clamps positioned on each end of the powered rails, each electric clamp having at least one resistor.

In accordance with another aspect of the disclosure, a dynamic charging system is disclosed. The dynamic charging system comprises: an electric rail infrastructure including: a plurality of powered rails; a plurality of energy interfaces positioned throughout the plurality of powered rails; a power module connected to the plurality of energy interfaces for providing electrical power to the plurality of powered rails; and a plurality of electric clamps positioned on each end of the powered rails, each electric clamp having at least one resistor. The dynamic charging system further comprises a work machine having: an arm assembly; and a rail connector on a free end of the arm assembly, the rail connector configured to contact the plurality of powered rails to receive electrical power for the work machine.

In accordance with another aspect of the disclosure, a method of installing an electrical rail infrastructure for electrically connecting to a work machine is disclosed. The method comprises: providing a plurality of powered rails; positioning a plurality of energy interfaces throughout the plurality of powered rails; connecting a power module to the plurality of energy interfaces for providing electrical power to the plurality of powered rails; and installing a plurality of electric clamps on each end of the powered rails, each electric clamp having at least one resistor.

These and other aspects and features of the present disclosure will be better understood upon reading the following detailed description when read in conjunction with the accompanying drawings.

### BRIEF DESCRIPTION OF THE DRAWINGS

FIG. 1 is a perspective view of a work machine and electric rail infrastructure, according to an embodiment of the present disclosure.

FIG. 2 is a perspective bottom view of the electric rail infrastructure, according to an embodiment of the present disclosure.

FIG. 3 is a bottom view of the electric rail infrastructure of FIG. 2, according to an embodiment of the present disclosure.

FIG. 4 is a perspective view of an interface plate, according to an embodiment of the present disclosure.

FIG. 5 is a perspective side view of the electric rail infrastructure, according to an embodiment of the present disclosure.

FIG. 6 is a block diagram of a dynamic charging system, according to an embodiment of the present disclosure.

FIG. 7 is a method of installing an electrical rail infrastructure to dynamically power a work machine, according to an embodiment of the present disclosure.

The figures depict one embodiment of the presented invention for purposes of illustration only. One skilled in the art will readily recognize from the following discussion that alternative embodiments of the structures and methods illustrated herein may be employed without departing from the principles described herein.

### DETAILED DESCRIPTION

Referring now to the drawings, and with specific reference to the depicted example, a work machine 100 is shown, illustrated as a battery-electric or diesel-electric machine, illustrating an exemplary application of an electrical rail infrastructure 102 for dynamically charging the work machine 100. The electrical rail infrastructure 102 is designed to provide dynamic continuous power to the work machine 100 while it is in operation, enhancing efficiency and reducing downtime. While the following detailed description describes an exemplary aspect in connection with a battery-electric or diesel-electric machine, it should be appreciated that the description applies equally to the use of the present disclosure in other machines that utilize dynamic charging systems, including, but not limited to, excavators, backhoes, front-end loaders, shovels, draglines, skid steers, wheel loaders, and tractors, as well. These machines are utilized in various industries, including construction, mining, and agriculture, to perform heavy-duty tasks. The electrical rail infrastructure 102 ensures that these machines receive continuous electrical power, allowing them to operate without frequent interruptions for recharging.

The electrical rail infrastructure 102 includes a plurality of electrified rails 104 installed to provide power along the working path of the work machine 100 defined by the length of the plurality of electrified rails 104. The plurality of electrified rails 104 are designed to deliver continuous electrical power to the machine's charging system, facilitating efficient energy transfer. The plurality of electrified rails 104 may include three rails aligned in parallel equidistant apart.

The work machine 100 contacts the plurality of electrified rails 104 via a rail connector 106 that contacts the plurality of electrified rails 104 to facilitate electrical connections. The rail connector 106 is an attachable and detachable component that facilitates the electrical connection between the work machine 100 and the plurality of electrified rails 104.

The power module 108 is integrated into the electrical rail infrastructure 102 to regulate and distribute the electrical power supplied to the plurality of electrified rails 104 and to the work machine 100 when the rail connector 106 contact the plurality of electrified rails 104. The power module 108 ensures that the electrical parameters such as voltage and current are maintained within safe and efficient operating levels, thus protecting the electrical systems of the work machine 100.

The power module 108 may be any type of energy container that produces energy such as generators, solar panels, fuel cells, engines, hybrid generators, and the like, as generally known in the arts.

The work machine 100 is equipped with an arm assembly 110, which extends from the work machine 100 to connect the rail connector 106 to the plurality of electrified rails 104, while the work machine 100 is moving and operating. The rail connector 106 and the arm assembly 110 are designed to provide a flexible and robust connection that can withstand the mechanical stresses and movements associated with the operation of the work machine 100 to ensure a reliable electrical connection is maintained, allowing for continuous power transfer even as the work machine 100 moves and operates in various conditions.

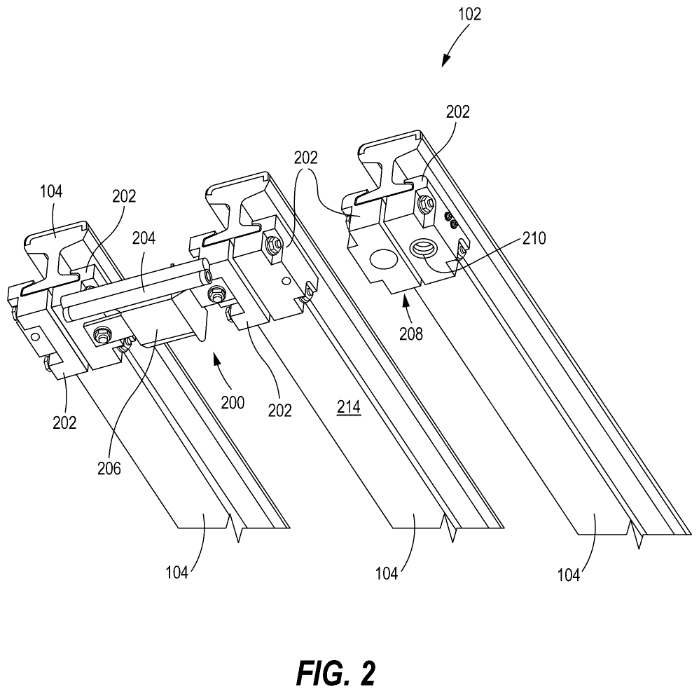

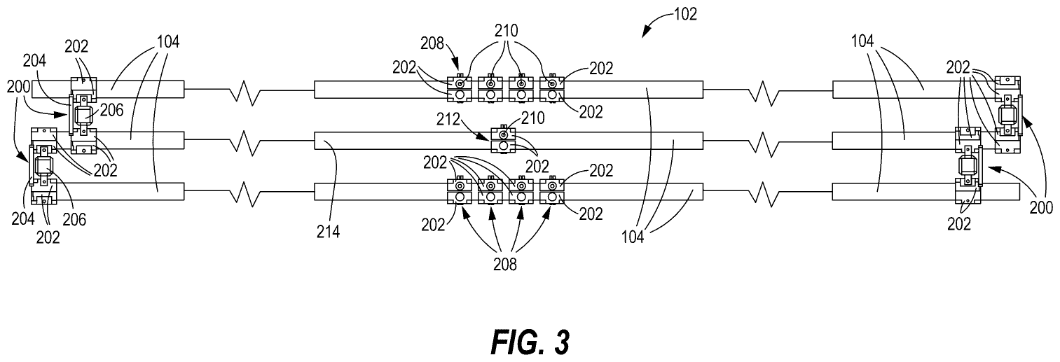

Referring now to FIG. 2 and FIG. 3 illustrating the electrical rail infrastructure 102. FIG. 2 illustrates a perspective view of the electrical rail infrastructure 102, according to an embodiment of the disclosure. FIG. 3 illustrates a bottom view of the electrical rail infrastructure 102, according to an embodiment of the disclosure. The plurality of electrified rails 104 are arranged in parallel to each other to provide a continuous electrical connection for the work machine 100.

A plurality of electric clamps 200 are provided to connect at least two of the electrified rails 104 in the plurality of electrified rails 104. Each of the plurality of electric clamps 200 provided includes an interface plate 202, a resistor 204, and a surge protector 206. Mechanical and electrical connections between adjacent rails are may be established using a splice plate that wedges into the web of the rail and clamps two rail segments together using bolts. Interface plate 202 provides mounting provisions for the surge protector 206, and resistor 204, and provides an electrical connection between positive and ground rails, and ground and negative rails. The interface plate 202 be a metal plate configured to attach or interface with the plurality of electrified rails 104.

The resistor 204 integrated within the electric clamp 200 functions to limit the electrical current and protect against electrical surges, thereby preventing potential damage to the system.

The surge protector 206 offers protection against voltage spikes that may occur, ensuring the stability and reliability of the power supply from the plurality of electrified rails 104 to the work machine 100.

A plurality of power module connectors 208 are also provided on a plurality of positions along the plurality of electrified rails 104 to connect to the power module 108 for electrifying the plurality of electrified rails 104.

The plurality of the power module connectors 208 may utilize a cable interface 210, such as sockets, for connecting the power module 108 to the plurality of electrified rails 104 utilizing AC/DC cables, and the like, for power transfer from the power module 108 to the plurality of electrified rails 104. The plurality of power module connectors 208 may attach to the plurality of electrified rails 104 utilizing the interface plate 202. The cable interface 210 is designed to handle high current loads and ensure a secure and efficient electrical connection between the power module 108, an AC or DC cable, and the plurality of electrified rails 104.

A plurality of electric ground connectors 212 are also provided on the plurality of electrified rails 104, which may utilize the cable interface 210, such as a socket, for ground cable connection. In one embodiment, the plurality of electric ground connectors 212 are positioned on the center rail dedicated a ground rail 214 for sending voltage spikes to ground. The plurality of electric ground connectors 212 may be the same as the plurality of the power module connectors 208, wherein the plurality of electric ground connectors 212 connect to a ground cable. The plurality of electric ground connectors 212 and the plurality of the power module connectors 208 may be referred to as a plurality of energy interfaces for electrifying the plurality of electrified rails 104.

The power module 108 are placed to regulate and distribute electrical power efficiently across the entire length of the rails 104 and connected to a plurality of the power module connectors 208. The plurality of electrified rails 104 are designed to accommodate multiple sections connected end-to-end, creating a continuous path for dynamic power delivery to the work machine 100 as it travels and operates along the plurality of electrified rails 104. The electric clamps 200 are assembled to a bottom flange on the electrified rails 104, with the resistor 204, and the surge protector 206 spanning the distance between the electrified rails 104 from below so as to not interfere with the work machine 100 as it passes on top of the electrified rails 104.

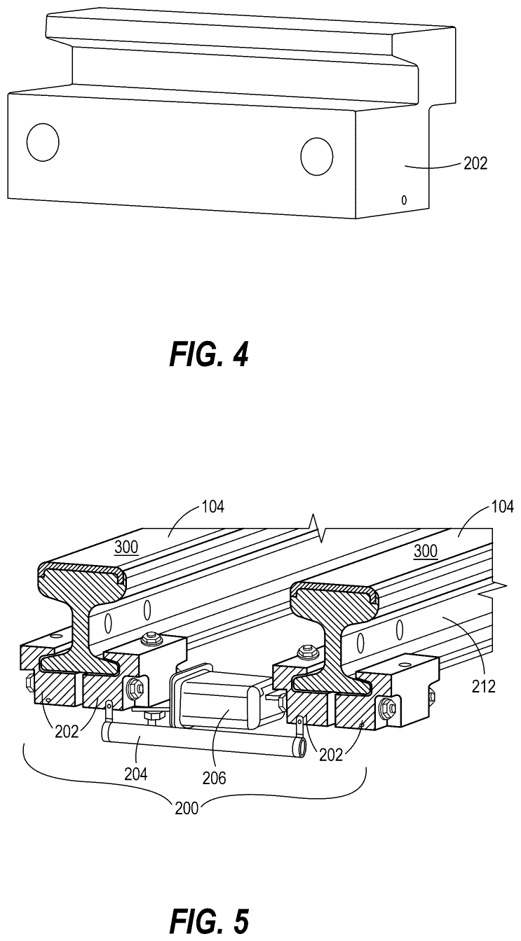

Now referring to FIG. 4, a perspective side view of the interface plate 202 is illustrated, according to an embodiment of the disclosure. The interface plate 202 may be made of metal and configured to attach the plurality of electric clamps 200 to plurality of electrified rails 104. The configuration of the interface plate 202 may be utilized to attach the plurality of power module connectors 208 to the plurality of electrified rails 104. The interface plate 202 may be included in the plurality of electric clamps 200, the plurality of the power module connectors 208, and plurality of electric ground connectors 212.

The interface plate 202 is designed to attach the electric clamp 200 and/or the power module connectors 208 securely to the electric powered rails 104. The interface plate 202 features a robust rectangular structure with a flat bottom surface for stable attachment to the rail. The interface plate 202 may include a double-tiered or stepped design, which ensures a secure and precise fit against the electric powered rails.

The interface plate 202 is equipped with holes configured for bolts that secure the interface plate 202 to the rail sections, providing a strong and stable connection. Additionally, the interface plate 202 may be configured for bolts that secure the interface plate 202 to a corresponding interface plate 202 for fastening the pair of interface plates 202 to the rail sections, providing a strong and stable connection.

The interface plate 202 ensures that the electric clamp 200 and power module connectors 208 remain firmly attached to the plurality of electrified rails 104, facilitating efficient power transfer and maintaining the integrity of the dynamic charging system 400. This secure attachment is crucial for the continuous and reliable operation of the work machine 100 as it moves along the plurality of electrified rails 104. The interface plate 202 may be provided in pairs such as male and female counterparts bolted together and configured to form secure connections on the plurality of electrified rails 104.

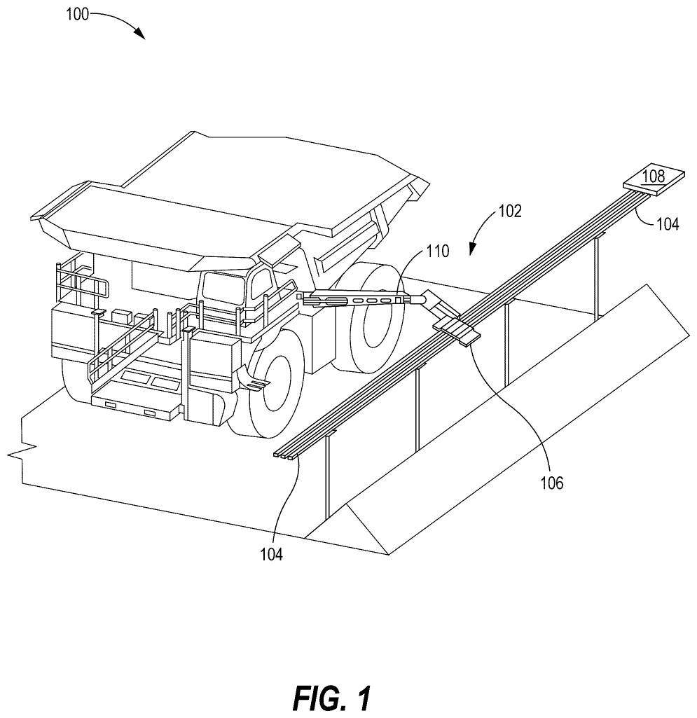

Now referring to FIG. 5, a perspective side view of an end of the electrical rail infrastructure 102 of FIG. 1 is illustrated, according to an embodiment of the disclosure. The plurality of electrified rails 104 may include a metal plate 300 provided along the length of the plurality of electrified rails 104 in which the rail connector 106 makes contact to facilitate electrical connection. The plurality of electrified rails 104 may be made of aluminum or another metal that promotes conductivity.

Each electric clamp 200 connects to an end of the plurality of electrified rails 104 using its own pair of interface plates 202, which may be referred to as interface plates. Each electric clamp 200 connects to at least one ground rail 214. In one embodiment, two interface plates 202 may be used to connect each end of the electric clamp 200 to one of the plurality of electrified rails 104, such as two adjacent rails. These interface plates 202 are bolted together around each rail, securing the connection, and providing structural integrity. Each electric clamp 200 includes the pair of interface plates 202 for mechanically joining each end of the electric clamp 200 to two powered rails 104, as shown in FIG. 2. In one embodiment, each electric clamp 200 connects two rails using a total of four interface plates 202, as shown in FIG. 2.

Additionally, power module connectors 208 have their own pairs of interface plates 202 configured for attachment to the plurality of electrified rails 104. These connectors house the cable interface 210 which connect to electrical cables to supply electrical power from the power module 108 to the plurality of electrified rails 104, ensuring efficient power transfer across the rail infrastructure.

The plurality of electric ground connectors 212, which connect to the plurality of electrified rails 104 also uses its own pair of interface plates 202 that is configured to includes a cable interface 210. These interface plates 202 secure the electric ground connectors 212 to at least one of the powered rails 104, ensuring that any excess electrical current is safely dissipated to the ground. For example, one electric ground connectors 212 may be provided on the center rail in the plurality of powered rails 104, as shown in FIG. 3.

The electric clamps 200 also include a surge arrestor that bleeds voltage surges to the ground rail 214. This feature is crucial for reducing the impact of lightning strikes by directing the electrical surge to the ground. The system may be grounded every 6 meters, ensuring consistent and effective grounding throughout the rail infrastructure. For example, the electric clamps 200 may connect each outside rail in the plurality of powered rails 104 to the center rail in the plurality of powered rails 104, as shown in FIG. 3, to direct electrical power to the center rail in the plurality of powered rails 104, as shown in FIG. 3, so that any voltage surge and electrical power may be directed to at least one of the electric ground connectors 212 to direct electrical surge to the ground.

A tubular resistor 204 is integrated into the electric clamp 200 as part of the ground fault detection system. This resistor 204 helps in identifying and managing ground faults, enhancing the overall safety and reliability of the dynamic charging system 400.

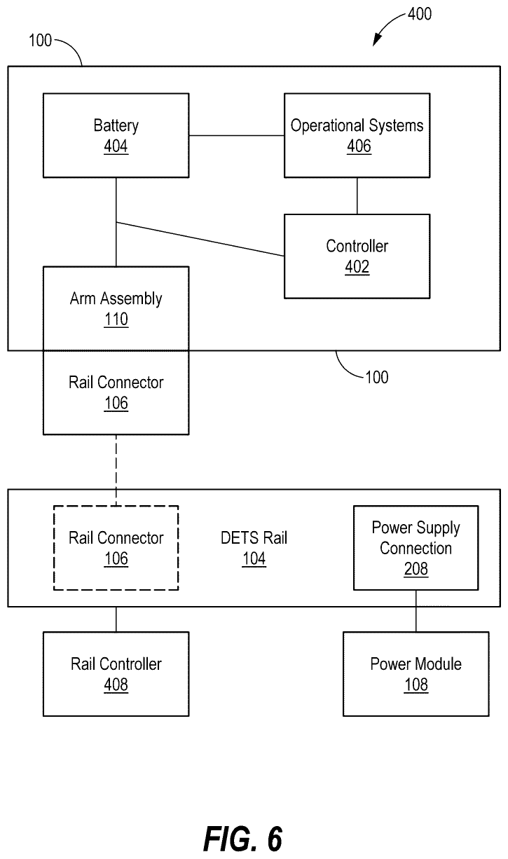

Now referring to FIG. 6, a block diagram of a dynamic charging system 400 for the work machine 100 is illustrated, according to an embodiment of the disclosure. The dynamic charging system 400 comprises a controller 402 and a battery 404 in the work machine 100. The controller 402 enables automating connection of the work machine 100 to the electrical rail infrastructure 102, as well as powering and managing a plurality of operational systems 406 associated with the work machine 100.

The modular design of the dynamic charging system 400 allows for easy expansion and maintenance. Additional rail sections, connectors, and power modules can be added as needed to accommodate different operational requirements and machine sizes. This flexibility makes the system highly adaptable to various industrial applications, including construction, mining, and agriculture.

The operational systems 406 controlled by the controller 402 include, but are not limited to, the ignition system, fuel injection system, oil transport system, transmission, throttle system, power system, braking system, cooling system, navigation system, lighting system, alarm system, battery system, and engine or other propulsion systems. The operational systems 406 may comprise hydraulic, mechanical, electronic, and software-based components that the controller 402 communicates with and controls, ensuring the seamless operation of the work machine 100 and the dynamic charging system 400.

The controller 402 interfaces with the electrical rail infrastructure 102 to regulate the electrical power supplied from the to the plurality of electrified rails 104 to the work machine 100. The controller 402 ensures that the voltage and current levels are maintained within safe and efficient operating parameters. The controller 402 also monitors the connection status of the arm assembly 110 and the rail connector 106, providing real-time feedback and diagnostic information to the operator.

A rail controller 408 may be provided on the electrical rail infrastructure 102 for monitoring the status of the of the electrical rail infrastructure 102 to monitor the condition and performance of the rail system via sensors provide that can detect anomalies such as voltage drops, rail misalignments, or excessive wear. The data collected by these sensors can be transmitted to the rail controller 408 and further to a central control system for real-time analysis and predictive maintenance, ensuring optimal operation and minimizing downtime

The plurality of electrified rails 104 can be designed to support both AC and DC power transmission. This dual capability allows the system to be compatible with a wider range of power sources and machinery, providing greater flexibility in various industrial applications. The power module 108 can automatically switch between AC and DC modes based on the power requirements of the connected work machine 100.

In another embodiment, the electrical rail infrastructure 102 may incorporate a wireless communication system that interfaces with the controller 402 of the work machine 100 to monitor and adjust the power distribution based on real-time data such as the machine's location, speed, and operational status. By integrating sensors and a communication module, the dynamic charging system 400 ensures optimal power delivery and enhances the efficiency of the dynamic charging process.

The plurality of electrified rails 104 may also be equipped with a fail-safe mechanism that deactivates the power supply in case of a detected fault or disconnection of the rail connector 106. This safety feature minimizes the risk of electrical hazards and ensures that maintenance and troubleshooting can be conducted safely and efficiently.

The dynamic charging system 400 is designed to be adaptable for integration with various types of work machines. The system can be configured with different types of connectors and interface modules to accommodate machines with different power requirements and operational specifications. This modularity allows for easy customization and scalability of the electrified rail infrastructure system.

### Industrial Applicability

In operation, the present disclosure may find applicability in many industries including, but not limited to, the construction, mining, and agricultural industries. Specifically, the systems, machines, and methods of the present disclosure may be used for dynamically charging work machines such as excavators, backhoes, front-end loaders, shovels, draglines, skid steers, wheel loaders, and tractors. The dynamic charging system 400 described herein ensures that these machines receive continuous electrical power, allowing them to operate without frequent interruptions for recharging, thereby enhancing efficiency and reducing downtime.

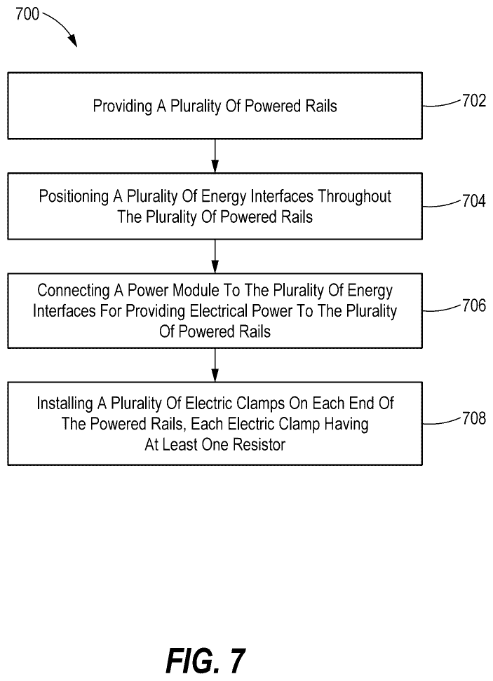

Now referring to FIG. 7, a flow chart of a method 700 for installing the electrical rail infrastructure 102 for electrically connecting to the work machine 100 is illustrated, according to an embodiment of the disclosure.

In a step 702, a plurality of electrified rails 104 is provided. This involves installing the plurality of electrified rails 104 along the working path of the work machine 100. The plurality of electrified rails 104 are designed to deliver continuous electrical power to the work machine 100 as it operates, ensuring that the machine remains charged without frequent interruptions.

In a step 704, a plurality of energy interfaces are positioned throughout the plurality of electrified rails 104. These energy interfaces serve as connection points for the power module 108 that will supply electricity to the plurality of electrified rails 104, facilitating efficient energy distribution along the entire working path.

In a step 706, a power module 108 is connected to the plurality of energy interfaces for providing electrical power to plurality of electrified rails 104. These power module 108 are responsible for regulating and distributing electrical power to the plurality of electrified rails 104, ensuring that the work machine 100 receives a consistent and reliable power supply.

In a step 708, a plurality of electric clamps 200 is installed on each end of plurality of electrified rails 104, each electric clamp 200 having at least one resistor 204. The plurality of electric clamps 200 are equipped with resistors 204 to manage electrical current and protect the system from potential surges. The resistors 204 help maintain stable operation by limiting excessive current flow, thereby preventing damage to the electrical infrastructure. One of the resistors 204 may be the surge protector 206.

Additionally, the method 700 may include the installation of a ground rail 214 in the center of the plurality of electrified rails 104. The ground rail 214 is dedicated to handling voltage spikes and ensuring the safe dissipation of excess electrical current. The ground rail 214 enhances the safety and reliability of the dynamic charging system 400 by providing a clear path for grounding electrical surges.

From the foregoing, it can be seen that the technology disclosed herein has industrial applicability in a variety of settings, including, but not limited to, stationary electrical infrastructure, and rail infrastructure.

What is claimed is:

1. An electric rail infrastructure for a work machine, comprising:
a plurality of powered rails;
a plurality of energy interfaces positioned throughout the plurality of powered rails;
a power module connected to the plurality of energy interfaces for providing electrical power to the plurality of powered rails;
a plurality of electric clamps positioned on each of the powered rails, each electric clamp having at least one resistor.

2. The electric rail infrastructure of claim 1, wherein the plurality of powered rails are aligned in parallel and equidistant from each other to facilitate continuous electrical connection with the work machine, and wherein each electric clamp includes a pair of interface plates for mechanically joining each end of the electric clamp to two powered rails.

3. The electric rail infrastructure of claim 1, wherein each electric clamp further comprises a surge protector for protecting the electrical rail infrastructure from voltage spikes.

4. The electric rail infrastructure of claim 1, wherein a rail controller is configured to regulate and distribute the electrical power supplied to the plurality of powered rails from the power module.

5. The electric rail infrastructure of claim 1, wherein the power module includes a plurality of energy sources selected from the group consisting of generators, solar panels, fuel cells, and hybrid generators.

6. The electric rail infrastructure of claim 1, wherein the plurality of powered rails includes a metal plate along a surface of each rail.

7. The electric rail infrastructure of claim 2, wherein the plurality of electric clamps connect an outside rail in the plurality of powered rails to a center rail in the plurality of powered rails, to direct electrical surges to the center rail in the plurality of powered rails and to at least one of the electric ground connectors positioned on the center rail.

8. The electric rail infrastructure of claim 1, further comprising a controller configured to automate the connection of the work machine to the electrical rail infrastructure, and to manage the power distribution to the work machine's operational systems, wherein the controller is configured to communicate with a remote control device for remotely managing the operation of the dynamic charging system.

9. The electric rail infrastructure of claim 1, wherein the plurality of energy interfaces includes an interface plate with a socket for receiving electrical cables connected to the power module.

10. The electric rail infrastructure of claim 1, wherein the plurality of energy interfaces includes an interface plate with a socket for receiving electrical cables.

11. A dynamic charging system comprising:
an electric rail infrastructure including:
a plurality of powered rails;
a plurality of energy interfaces positioned throughout the plurality of powered rails;
a power module connected to the plurality of energy interfaces for providing electrical power to the plurality of powered rails;
a plurality of electric clamps positioned on each end of the powered rails, each electric clamp having at least one resistor; and
a work machine having:
an arm assembly; and
a rail connector on a free end of the arm assembly, the rail connector configured to contact the plurality of powered rails to receive electrical power for the work machine.

12. The dynamic charging system of claim 12, wherein each electric clamp further includes a surge protector to safeguard the electric rail infrastructure from voltage spikes and ensure the stability of the power supply.

13. The dynamic charging system of claim 12, wherein the power module comprises multiple energy sources selected from the group consisting of generators, solar panels, fuel cells, and hybrid generators, to provide a power supply to the plurality of powered rails.

14. The dynamic charging system of claim 12, further comprising a controller configured to automate the connection of the rail connectors of the work machine to the electrical rail infrastructure, and to manage the power distribution to operational systems of the work machine.

15. The dynamic charging system of claim 12, wherein the plurality of electric clamps each includes a pair of interface plates for mechanically joining each end of each electric clamp to connect two powered rails in the plurality of powered rails.

16. The dynamic charging system of claim 15, wherein the plurality of electric clamps connect an outside rail in the plurality of powered rails to a center rail in the plurality of powered rails, to direct electrical surges to the center rail in the plurality of powered rails and to at least one of the electric ground connectors positioned on the center rail.

17. A method of installing an electrical rail infrastructure for electrically connecting to a work machine, the method comprising:
providing a plurality of powered rails;
positioning a plurality of energy interfaces throughout the plurality of powered rails;
connecting a power module to the plurality of energy interfaces for providing electrical power to the plurality of powered rails; and
installing a plurality of electric clamps on each end of the powered rails, each electric clamp having at least one resistor.

18. The method of claim 17, further comprising:
providing an arm assembly on the work machine; and
attaching a rail connector to a free end of the arm assembly, the rail connector configured to contact the plurality of powered rails to receive electrical power for the work machine.

19. The method of claim 17, wherein the plurality of electric clamps each includes a pair of interface plates for mechanically joining each end of each electric clamp to connect two powered rails in the plurality of powered rails, the method further comprising:
installing surge protectors within each electric clamp to protect the electrical rail infrastructure from voltage spikes; and
connecting the plurality of electric clamps to an outside rail in the plurality of powered rails to a center rail in the plurality of powered rails, to direct electrical surges to the center rail in the plurality of powered rails and to at least one of the electric ground connectors positioned on the center rail.

20. The method of claim 17, further comprising:
connecting energy sources to the power module, the energy sources selected from the group consisting of generators, solar panels, fuel cells, and hybrid generators, to provide power supply to the plurality of powered rails.
